(19) United States
(12) Patent Application Publication
(10) Pub. No.: US 2015/0212382 A1
(43) Pub. Date: Jul. 30, 2015

(54) ELECTROCHROMIC ELEMENT, AND IMAGE PICKUP OPTICAL SYSTEM, IMAGE PICKUP DEVICE, AND WINDOW MEMBER, EACH USING THE ELECTROCHROMIC ELEMENT

(71) Applicant: CANON KABUSHIKI KAISHA, Tokyo (JP)

(72) Inventor: Kazuya Miyazaki, Kunitachi-shi (JP)

(21) Appl. No.: 14/596,658

(22) Filed: Jan. 14, 2015

(30) Foreign Application Priority Data
Jan. 27, 2014 (JP) 2014-011977

(51) Int. Cl. G02F 1/155; H04N 5/369; G02F 1/15

(52) U.S. Cl. CPC G02F 1/155; G02F 1/1521; H04N 5/369; G02F 2001/1512

(57) ABSTRACT

Provided is an electrochromic element that is excellent in reliability by virtue of a decreased driving voltage, the electrochromic element including: a pair of electrodes; and an electrochromic medium including a liquid containing an electrochromic material, the electrochromic medium being arranged between the pair of electrodes, in which: the electrochromic material includes at least one kind of anodic electrochromic material and at least one kind of cathodic electrochromic material; the pair of electrodes includes a first electrode configured to perform oxidation-reduction of the anodic electrochromic material and a second electrode configured to perform oxidation-reduction of the cathodic electrochromic material; and a specific surface area of the second electrode is larger than a specific surface area of the first electrode.

### BACKGROUND OF THE INVENTION

1. Field of the Invention

The present invention relates to an electrochromic element for controlling a light intensity and color. The present invention also relates to an image pickup optical system, an image pickup device, and a window member, each using the electrochromic element.

2. Description of the Related Art

In recent years, there has been an increasing demand for a variable ND filter capable of continuously adjusting an optical density in a video recording device using a solid-state image pickup element. As an optical element for this application, many optical elements using a liquid crystal or inorganic electrochromic thin film have heretofore been proposed. However, such optical elements have not yet attained widespread use because of their inferiority to conventional ND filters in terms of a light quantity adjustable range, reliability, and the like. On the other hand, an optical element using an organic electrochromic molecule has a wide light quantity adjustable range, and besides, its spectral transmittance can be relatively easily designed. Accordingly, this optical element is particularly promising in its application as a variable ND filter to be mounted in an image pickup device.

The electrochromic element using the organic electrochromic molecule often has the following construction: the electrochromic element includes, between a pair of electrodes, an electrochemically active anodic material and an electrochemically active cathodic material, in which at least one of the materials is a material having electrochromicity, that is, expressing an absorption band in a visible light region through electrochemical oxidation-reduction. In this case, on the pair of electrodes, an oxidation reaction of the anodic material and a reduction reaction of the cathodic material occur simultaneously, and thus a closed circuit is formed in the element to flow a current.

In U.S. Pat. No. 3451741 and SID Int. Symp. Digest pp. 22-23 (1978), there is described an element construction in which a reaction current of the anodic electrochromic material is complementarily compensated by a reaction current of the cathodic electrochromic material. In this connection, a driving voltage of the element is unambiguously determined by a potential difference between an oxidation potential of the anodic electrochromic material and a reduction potential of the cathodic electrochromic material. Accordingly, in order to obtain a large change in optical density in the element, it is preferred that a current be flowed by applying a higher potential difference than the above-mentioned potential difference. However, the application of the high potential difference causes, for example, corrosion of a transparent electrode and side reactions of the electrochromic materials, thus markedly impairing durability of the element. Accordingly, there has been desired an element construction in which a high current is obtained through application of a lower potential difference.

In the electrochromic element using the organic electrochromic molecule, when the construction in which the anodic material and the cathodic material are complementarily used is adopted, it is preferred for the variable ND filter application that each of a reduced form of the anodic material and an oxidized form of the cathodic material be free of any absorption band in the visible light region. However, the oxidation-reduction potential difference between the materials having such characteristics is high, and hence the element needs to be driven by a high voltage (potential difference). There is a problem in that the high driving voltage (potential difference) causes reduction corrosion of a transparent electrode and side reactions of the anodic material and the cathodic material, thus significantly impairing reliability of the element.

### SUMMARY OF THE INVENTION

The present invention has been made in view of the above-mentioned problem, and according to one embodiment of the present invention, there is provided an electrochromic element that is excellent in reliability by virtue of a decreased driving voltage of the element. According to other embodiments of the present invention, there are provided an image pickup optical system, an image pickup device, and a window member, each using the electrochromic element.

According to one embodiment of the present invention, there is provided an electrochromic element, including: a pair of electrodes; and an electrochromic medium including a liquid containing an electrochromic material, the electrochromic medium being arranged between the pair of electrodes, in which: the electrochromic material includes at least one kind of anodic electrochromic material and at least one kind of cathodic electrochromic material; the pair of electrodes includes a first electrode configured to perform oxidation-reduction of the anodic electrochromic material and a second electrode configured to perform oxidation-reduction of the cathodic electrochromic material; and a specific surface area of the second electrode is larger than a specific surface area of the first electrode. In addition, the second electrode has a porous structure formed by nanoparticles.

According to one embodiment of the present invention, there is provided an image pickup optical system, including: the electrochromic element; and a circuit configured to drive the electrochromic element.

According to one embodiment of the present invention, there is provided an image pickup device, including: the electrochromic element; a circuit configured to drive the electrochromic element; and an image pickup element configured to receive light that has passed through the electrochromic element.

According to one embodiment of the present invention, there is provided an image pickup device, including: a circuit configured to drive the electrochromic element; and an image pickup element configured to receive external light.

According to one embodiment of the present invention, there is provided a window member, including: the electrochromic element; and a circuit configured to drive the electrochromic element.

Further features of the present invention will become apparent from the following description of exemplary embodiments with reference to the attached drawings.

### BRIEF DESCRIPTION OF THE DRAWINGS

FIG. 1 is a schematic view illustrating an electrochromic element according to one embodiment of the present invention.

FIG. 2 is a graph showing the cyclic voltammogram characteristics of an anodic electrochromic material, a cathodic electrochromic material, and an electrode having a porous structure.

FIG. 3 is a graph showing a relationship between the oxidation threshold voltage of an anodic electrochromic material A and the specific surface area of a second electrode.

FIG. 4 is a graph showing a relationship between the oxidation threshold voltage of the anodic electrochromic material A and the specific surface area of a first electrode.

FIG. 5 is a schematic view illustrating an electrochromic element according to another embodiment of the present invention.

FIG. 6 is a graph showing the cyclic voltammogram characteristics of elements in Example 1 and Comparative Example 1.

FIGS. 7A and 7B show graphs showing current (FIG. 7A) and optical density responses (FIG. 7B) in the case where a constant voltage is applied to each of the elements in Example 1 and Comparative Example 1.

FIG. 8 is a graph showing the cyclic voltammogram characteristics of elements in Example 2 and Comparative Example 2.

FIGS. 9A and 9B show graphs showing current (FIG. 9A) and optical density responses (FIG. 9B) in the case where a constant voltage is applied to each of the elements in Example 2 and Comparative Example 2.

### DESCRIPTION OF THE EMBODIMENTS

Preferred embodiments of the present invention will now be described in detail in accordance with the accompanying drawings.

Constructions of electrochromic elements according to exemplary embodiments of the present invention are described in detail below for illustrative purposes with reference to the drawings. However, constructions, relative arrangements, and the like described in these embodiments are not intended to limit the scope of the present invention unless otherwise stated.

An electrochromic element according to the present invention includes: a pair of electrodes; and an electrochromic medium including a liquid containing an electrochromic material, the electrochromic medium being arranged between the pair of electrodes, in which: the electrochromic material includes at least one kind of anodic electrochromic material and at least one kind of cathodic electrochromic material; the pair of electrodes includes a first electrode configured to perform oxidation-reduction of the anodic electrochromic material and a second electrode configured to perform oxidation-reduction of the cathodic electrochromic material; and a specific surface area of the second electrode is larger than a specific surface area of the first electrode.

In addition, the electrochromic element according to the present invention adopts a construction in which the anodic electrochromic material and the cathodic electrochromic material are simultaneously subjected to oxidation-reduction on the pair of electrodes. The second electrode, which is configured to perform the oxidation-reduction of the cathodic electrochromic material, has a porous structure having a large specific surface area, and a potential at which a cathodic current resulting from this electrode structure starts to flow is a higher potential than the reduction potential of the cathodic electrochromic material. Accordingly, in the element, a potential difference to be applied between the pair of electrodes can be decreased. That is, the driving voltage (potential difference) of the element can be decreased, and thus reduction corrosion of a transparent electrode and side reactions of the anodic material and the cathodic material, which result from a high driving voltage, can be avoided. As a result, the reliability of the element as an optical element for a variable ND filter application can be significantly improved.

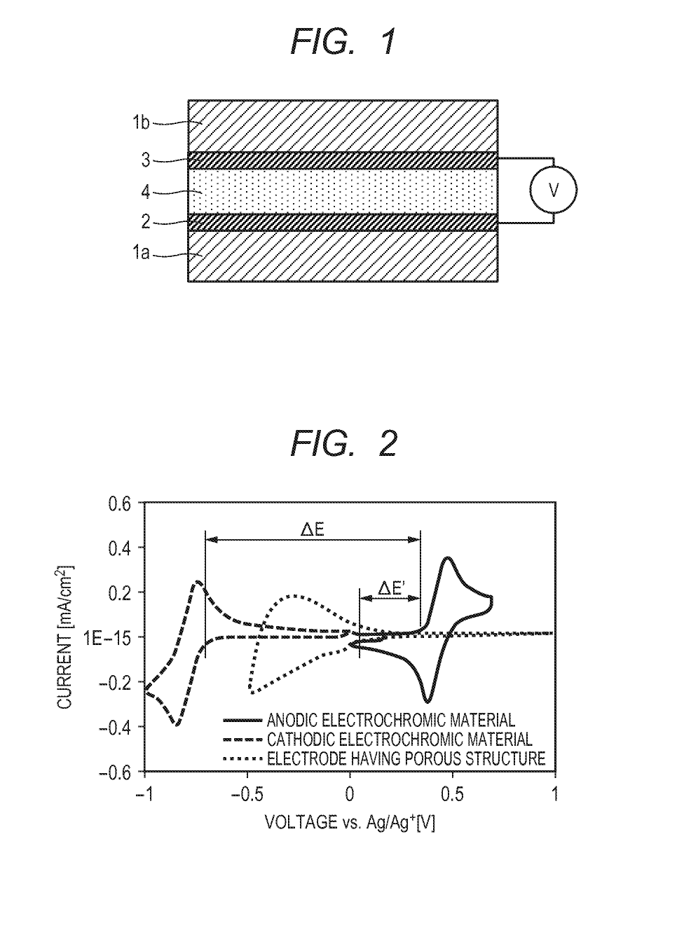

FIG. 1 is a schematic view illustrating an electrochromic element according to one embodiment of the present invention. In FIG. 1, there are illustrated glass substrates 1a, 1b. For each of the glass substrates, there may be used quartz glass, super white glass, borosilicate glass, alkali-free glass, chemically tempered glass, or the like, and particularly from the viewpoint of durability, an alkali-free glass substrate may be suitably used. The glass substrate 1a has formed thereon a first electrode 2 having a flat-surface or substantially flat-surface (hereinafter abbreviated as substantially flat) structure. On the other hand, the glass substrate 1b has formed thereon a second electrode 3 having a porous structure. An electrochromic medium 4 is formed of a liquid containing at least one kind of anodic electrochromic material and at least one kind of cathodic electrochromic material.

The electrochromic element of the present invention has a feature in that the specific surface area of the second electrode having a porous structure is larger than the specific surface area of the first electrode having a substantially flat structure. Herein, the substantially flat structure in the first electrode refers to such a structure that the specific surface area of the first electrode is from 1 cm²/cm² or more to 30 cm²/cm² or less. The case where the specific surface area is more than 30 cm²/cm² is not preferred because, in this case, the oxidation-reduction potential of the electrochromic material is increased.

The porous structure in the second electrode refers to such a structure that the specific surface area of the second electrode is preferably 300 cm²/cm² or more, more preferably 600 cm²/cm² or more. The case where the specific surface area is less than 300 cm²/cm² is not preferred because, in this case, a decrease in threshold voltage at which a current starts to flow in the element cannot be said to be sufficient.

The specific surface area in the present invention refers to a specific surface area (S_{B}/S_{A}: cm²/cm²) as the ratio of the effective area (S_{B}: cm²) of an electrode to its geometric area (S_{A}: cm²). It should be noted that the geometric area (S_{A}) has the same meaning as projected area, and refers to an apparent area (cm²) obtained when the substrate is projected. The effective area (S_{B}) refers to the internal surface area (cm²) of a porous structure calculated based on measurement by a nitrogen gas adsorption method (BET method) and measurement of a film weight.

Now, the reason why the specific surface area of the second electrode, which is configured to perform the oxidation-reduction of the cathodic electrochromic material, is set to be larger than that of the first electrode, which is configured to perform the oxidation-reduction of the anodic electrochromic material, is described with reference to FIG. 2.

FIG. 2 is a graph showing the cyclic voltammogram characteristics of an anodic electrochromic material, a cathodic electrochromic material, and an electrode having a porous structure. The potential reference of the horizontal axis is a reference electrode of a non-aqueous solvent system (Ag/Ag⁺). In FIG. 2, a potential at which an anodic current of the anodic electrochromic material starts to flow is about +0.31 V, and a potential at which a cathodic current of the cathodic electrochromic material starts to flow is about −0.70 V. Therefore, in an element in which an electrochromic medium containing these materials is sandwiched between a pair of substantially flat electrodes having no porous structure, when a threshold voltage (potential difference) is represented by ΔE, ΔE=1.01 V. On the other hand, in the electrode having a porous structure, a potential at which a cathodic current starts to flow is about +0.02 V. Therefore, in an element in which a medium containing only the anodic electrochromic material is sandwiched between a substantially flat first electrode and a second electrode having a porous structure, when the threshold voltage (potential difference) is represented by ΔE′, ΔE′=0.29 V. That is, the driving voltage (potential difference) of the element can be greatly decreased as compared to the element in which the anodic electrochromic material and the cathodic electrochromic material are sandwiched between the pair of substantially flat electrodes. Further, in an element in which a medium containing the anodic electrochromic material and the cathodic electrochromic material is sandwiched between the substantially flat first electrode and the second electrode having a porous structure, when the voltage is further increased while the threshold voltage (potential difference) is maintained at ΔE′=0.29 V, a reduction current of the cathodic electrochromic material flows, and hence the element can be driven at a lower driving voltage.

In order to achieve such effect, the oxidation-reduction potential of the electrode having a porous structure needs to be between those of the anodic electrochromic material and the cathodic electrochromic material. In particular, an electrode formed of a tin oxide-based nanoparticle film may be suitably used.

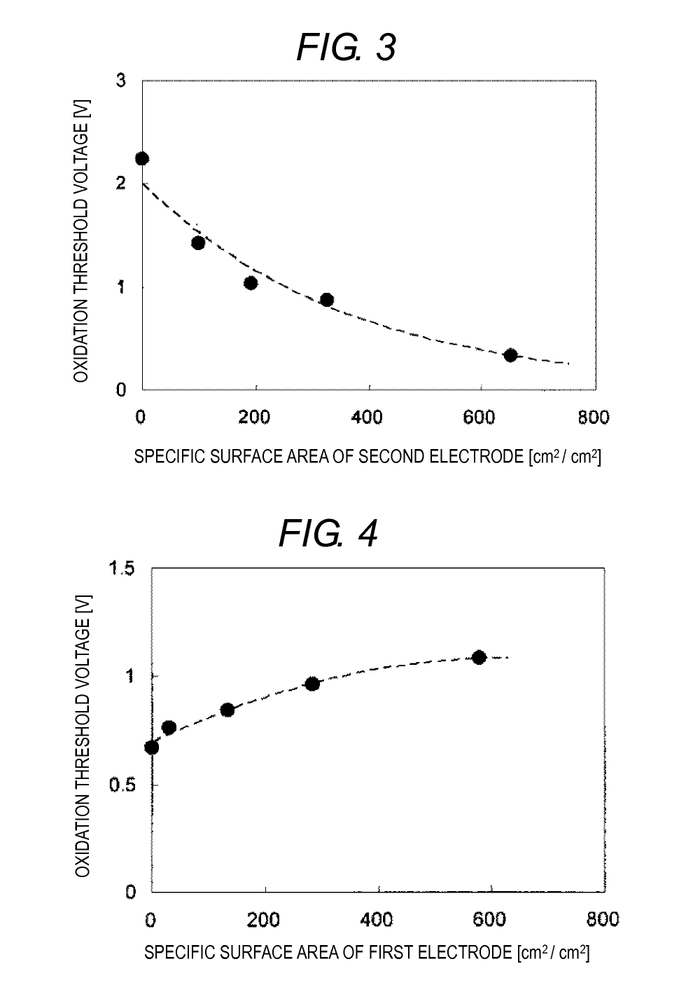

Now, a suitable specific surface area range of the second electrode having a porous structure is described. FIG. 3 is a graph showing a relationship between the oxidation threshold voltage of an anodic electrochromic material A represented by the following structural formula (A) and the specific surface area of the second electrode.

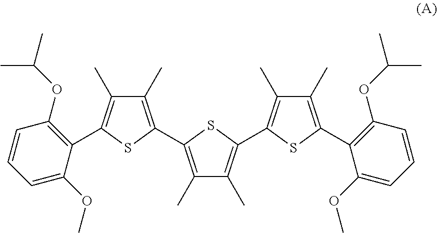 [SMILES: COc1cccc(OC(C)C)c1-c1sc(-c2sc(-c3sc(-c4c(OC)cccc4OC(C)C)c(C)c3C)c(C)c2C)c(C)c1C]

The threshold voltage refers to a voltage at which a change in optical density at the absorption wavelength of the electrochromic material, ΔOD (=−log(T/T₀)) (T represents a transmittance and T₀ represents an initial transmittance), becomes 0.01. In addition, a fluorine-doped tin oxide (FTO) thin film whose specific surface area can be regarded as approximately 1 cm²/cm² is used as the first electrode in this case. In FIG. 3, in contrast to the threshold voltage in the case of using an FTO thin film for the second electrode as well, i.e., 2.23 V, the threshold voltage is 1 V or less when the specific surface area of the second electrode is 300 cm²/cm² or more, and the threshold voltage can be further decreased to 0.5 V or less when the specific surface area is 600 cm²/cm² or more.

Therefore, the suitable specific surface area range of the second electrode having a porous structure is 300 cm²/cm² or more, more preferably 600 cm²/cm² or more.

Next, a suitable specific surface area range of the first electrode is described. FIG. 4 is a graph showing a relationship between the oxidation threshold voltage of the anodic electrochromic material A represented by the structural formula (A) and the specific surface area of the first electrode. The specific surface area of the second electrode in this case is set to 653 cm²/cm². In this case, it is found that: when the specific surface area of the first electrode is 1 cm²/cm², that is, when the substantially flat structure is adopted without forming a layer having a porous structure, the oxidation threshold voltage is lowest; and even when the specific surface area is slightly increased to 30 cm²/cm², the oxidation threshold voltage increases by 0.1 V or more.

Therefore, the suitable specific surface area range of the first electrode is from 1 cm²/cm² or more to 30 cm²/cm² or less.

As a material for the first electrode having a substantially flat structure, there may be used thin films formed of so-called transparent conductive oxides such as tin-doped indium oxide (ITO), zinc oxide, gallium-doped zinc oxide (GZO), aluminum-doped zinc oxide (AZO), tin oxide, antimony-doped tin oxide (ATO), fluorine-doped tin oxide (FTO), and niobium-doped titanium oxide (TNO). Further, in consideration of conductivity and high transparency, a laminate construction of those materials may be adopted. A film formation method for the first electrode only needs to allow its specific surface area to be 30 cm²/cm² or less, and is not limited to film formation methods such as: vapor-phase film formation methods including sputtering, vapor deposition, and CVD; and liquid-phase film formation methods including sol-gel, spin coating, printing, and plating. In particular, as a material that has both a high visible light transmittance and chemical stability, an FTO thin film having a thickness of about 200 nm may be suitably used. It is desired that the first electrode have a thickness of from 100 nm or more to 1,000 nm or less, preferably from 200 nm or more to 500 nm or less.

As a material for the second electrode having a porous structure, there may be used, for example, tungsten oxide, cerium oxide, or a composite oxide thereof as well as the transparent conductive oxides described above as the material for the first electrode. Herein, the shape of the second electrode having a porous structure and a production method therefor are not limited as long as the requirement concerning the specific surface area described above, and requirements concerning optical characteristics to be described later are satisfied. For example, a nanoparticle film having through-holes or a nanostructure such as a nanorod, a nanowire, or a nanotube may be used. In particular, a tin oxide nanoparticle film that has a large specific surface area per volume and is excellent in optical characteristics may be suitably used. It is desired that the second electrode have a thickness of 1,500 nm or more, preferably 3,000 nm or more.

Now, the requirements concerning the optical characteristics of the second electrode having a porous structure are described. It is preferred that the electrochromic element of the present invention be a transmissive element to be arranged in an optical path in an image pickup device or the like, and have a high visible light transmittance and a low haze. Particularly when the above-mentioned use is taken into consideration, the visible light transmittance is preferably 80% or more, more preferably 90% or more. The haze value is preferably 1% or less, more preferably 0.5% or less. As a preferred form of the porous structure capable of realizing the above-mentioned optical characteristics, there may be particularly suitably used a nanoparticle film having an average particle size of 40 nm or less, an average pore size of 30 nm or less, and an arithmetic average roughness of 50 nm or less.

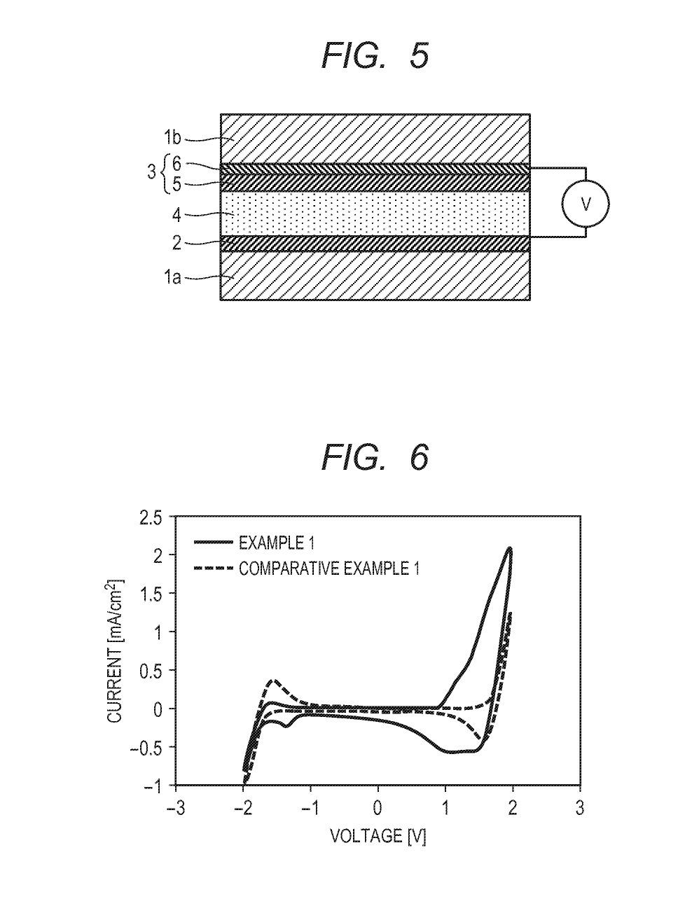

FIG. 5 is a schematic view illustrating an electrochromic element according to another embodiment of the present invention. The electrochromic element of FIG. 5 has a feature in that the second electrode 3 having a porous structure has a laminate structure including a layer 5 having a porous structure and a transparent conductive layer 6, the layer 5 having a porous structure being arranged on the electrochromic medium 4 side. In this construction, when the layer 5 having a porous structure has a high sheet resistance, the high sheet resistance is compensated by the transparent conductive layer 6 having a low resistance.

The electrochromic medium 4 is formed of a liquid containing at least one kind of anodic electrochromic material, at least one kind of cathodic electrochromic material, and a supporting electrolyte.

The anodic electrochromic material and the cathodic electrochromic material are each a transparent material that has no absorption in a visible light region in a neutral state. The anodic electrochromic material is a material that absorbs light having a specific wavelength in the visible light region when being oxidized. The cathodic electrochromic material is a material that absorbs light having a specific wavelength in the visible light region when being reduced. When a plurality of materials each having a different absorption band in the visible light region are mixed, the element can be allowed to have flat absorption characteristics. Specific examples of the anodic electrochromic material include thiophenes, and specific examples of the cathodic electrochromic material include viologens.

The supporting electrolyte may be added to the electrochromic medium. The supporting electrolyte is not particularly limited as long as its reactivity with the electrode materials is so low as to allow stable use. A plurality of supporting electrolytes may be used in combination. There may be used a salt formed of an alkali metal cation of lithium or the like or an organic cation such as a quaternary ammonium cation, and an inorganic anion such as a perchlorate anion.

As a solvent for dissolving the electrochromic materials, the supporting electrolyte, and the like, there may be used a polar aprotic solvent such as propylene carbonate, γ-butyrolactone, benzonitrile, N-methylpyrrolidone, 3-methoxypropionitrile, or N,N-dimethylacetamide, in consideration of, for example, solubility, a vapor pressure, viscosity, or a potential window.

In addition, a dehydrating agent, a stabilizing agent, a thickening agent, or the like may be added to the electrochromic medium in addition to the above-mentioned constituent substances.

Next, a process for injecting the electrochromic medium into the element is described.

The glass substrate 1a having formed thereon the first electrode 2 having a substantially flat structure, and the glass substrate 1b having formed thereon the second electrode 3 having a porous structure are joined through the use of an encapsulating material with the electrodes being on the inside and a partial opening being left. As the encapsulating material, there may be used a material that is chemically stable, is impervious to gas or water, and does not inhibit the oxidation-reduction reactions of the electrochromic materials, such as glass frit, an epoxy resin, or a metal. The encapsulating material may have a function of regulating a distance between the pair of the glass substrates, or a spacer may be separately arranged. The element joined with a partial opening being left is sealed after the electrochromic medium 4 has been injected thereinto through the opening by a vacuum injection method.

Next, an image pickup optical system and image pickup device according to the present invention are described.

An image pickup optical system according to the present invention includes: the electrochromic element; and a circuit configured to drive the electrochromic element.

An image pickup device according to the present invention includes: the electrochromic element; a circuit configured to drive the electrochromic element; and an image pickup element configured to receive light that has passed through the electrochromic element.

An image pickup device according to the present invention includes: a circuit configured to drive the electrochromic element; and an image pickup element configured to receive external light.

When the electrochromic element of the present invention is used in the image pickup device, such as a camera, a light quantity can be decreased without lowering the gain of the image pickup element. In its use in the image pickup device, the electrochromic element may be included in an image pickup optical system, or may be included in the main body of the image pickup device.

When the image pickup optical system includes the electrochromic element, the electrochromic element may be used at any one of the following positions: between a subject and the image pickup optical system; between the image pickup optical system and the image pickup element; and between lenses for forming the image pickup optical system. In this case, the electrochromic element is driven by, for example, a signal from a circuit configured to drive the electrochromic element included in the main body.

When the image pickup device includes the electrochromic element, the electrochromic element is provided, for example, in front of the image pickup element. The image pickup element includes a circuit configured to drive the electrochromic element, and the electrochromic element is driven by a signal from the circuit.

In addition, a window member according to the present invention includes: the electrochromic element; and a circuit configured to drive the electrochromic element. The electrochromic element of the present invention, when used in the window member, such as a window glass, can serve as an electronic curtain, a transmission filter, or the like. When the electrochromic element is provided in the window member, a known material for a window member may be used, and the window member may be constructed by arranging the electrochromic element between, for example, tempered glasses.

The window member including the electrochromic element can be used as a filter for a window of a house, a window of an airplane, a window of an automobile or a train car, or a display surface of a timepiece or a mobile phone.

Examples of the present invention are described below.

### EXAMPLE 1

The electrochromic element according to the embodiment illustrated in FIG. 5 was produced as described below.

A fluorine-doped tin oxide (PTO) thin film having a thickness of 200 nm was formed on a glass substrate having a thickness of 0.7 mm (manufactured by Corning Incorporated, #1737) to prepare the glass substrate la having formed thereon the first electrode 2 having a substantially flat structure. In this case, the glass substrate with the FTO thin film had an average visible light transmittance of 85%, a haze of 0.1%, and a sheet resistance of 40 ohms per square (Ω/□). In this case, the specific surface area of the first electrode can be regarded as approximately 1 cm²/cm².

Next, a tin oxide nanoparticle slurry having an average particle size of 21 nm (product No.: SNAP15WT %-G02, product of CIK NanoTek Corporation) and a zinc oxide nanoparticle slurry having an average particle size of 34 nm (product No.: ZNAP15WT %-G0, product of CIK NanoTek Corporation) were mixed so that the volume ratio of tin oxide:zinc oxide was 2:1, and a small amount of an inorganic binder for film surface flatness improvement and peeling prevention was further added to the mixture to obtain a nanoparticle mixed slurry. The mixed slurry was applied onto the same kind of glass substrate with an FTO thin film as above so as to be formed into a film, and was fired under the conditions of 500° C. and 30 minutes. After that, only the zinc oxide was etched with dilute hydrochloric acid to obtain a tin oxide nanoparticle film. In this case, the tin oxide nanoparticle film had a specific surface area of 653 cm²/cm², a visible light transmittance of 87%, and a haze of 0.6%. Thus, the glass substrate 1b having formed thereon the second electrode 3 formed of a laminate structure including the tin oxide nanoparticle film as the layer 5 having a porous structure and the FTO thin film as the transparent conductive layer 6 was prepared.

Next, the pair of substrates with electrodes was joined through the use of an epoxy resin with the electrodes being on the inside and an opening for electrochromic medium injection being left. At this time, a PET film having a thickness of 125 μm (manufactured by Teijin DuPont Films, Melinex (Trade Mark) S-125) was used as a spacer.

Next, an anodic electrochromic material B represented by the following structural formula (B), a cathodic electrochromic material C (chemical name: 2-ethylanthraquinone) represented by the following structural formula (C), and tetrabutylammonium (TBAP) as a supporting electrolyte were dissolved in a propylene carbonate solvent to prepare the electrochromic medium 4. In this case, the concentrations of the anodic electrochromic material B and the cathodic electrochromic material C were each set to 50 mM, and the concentration of TBAP was set to 0.1 M.

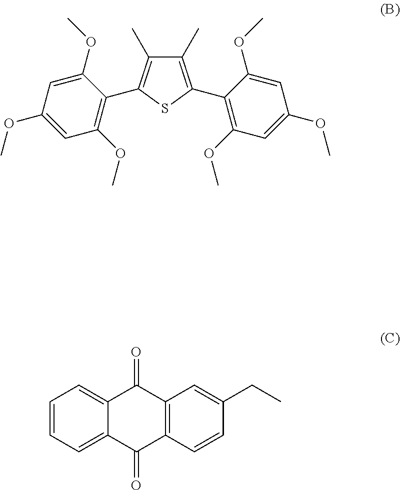

The electrochromic medium was injected into the previously prepared empty element joined with an opening being left, by a vacuum injection method through the opening, and then the opening was sealed with an epoxy resin to produce an electrochromic element.

### COMPARATIVE EXAMPLE 1

In the second electrode of Example 1, the layer having a porous structure was not formed, and an element using an FTO thin film having a substantially flat structure as each of the first and second electrodes was produced. All the other conditions were the same as those in Example 1.

<Element Evaluation>

The electrochromic elements produced in Example 1 and Comparative Example 1 were each arranged in an evaluation system in which electrochemical measurement and transmittance measurement could simultaneously be performed, and were evaluated for their current-voltage characteristics and transmittance characteristics. FIG. 6 is a graph showing the cyclic voltammogram characteristics of the elements in Example 1 and Comparative Example 1.

The threshold voltage of the element of Comparative Example 1 is 1.59 V, whereas the threshold voltage of Example 1 is 1.06 V. Thus, it is found that the formation of the layer having a porous structure in the second electrode allows a current to start flowing at a lower voltage, initiating coloration. Further, it is found that: the cyclic voltammogram waveform of the element of Example 1 has an inflection point around 1.4 V; in the voltage range of from the threshold voltage, i.e., 1.06 V or more to 1.4 V or less, a reaction between the anodic electrochromic material B and the second electrode having a porous structure has occurred; and at 1.4 V or more, a reaction between the anodic electrochromic material B and each of the second electrode having a porous structure and the cathodic electrochromic material C has occurred. On the other hand, in the element of Comparative Example 1, at voltages ranging from the threshold voltage, i.e., 1.59 V or more, a reaction between the anodic electrochromic material B and the cathodic electrochromic material C has occurred. That is, it is found that the formation of the layer having a porous structure has been able to decrease the voltage at which the reaction of the cathodic electrochromic material C starts by about 0.2 V.

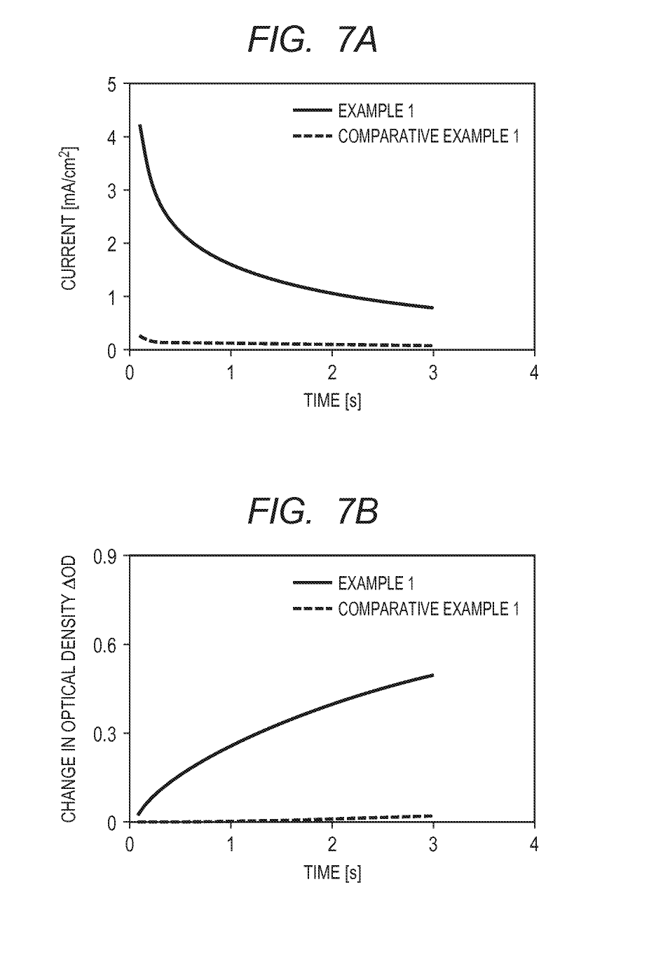

FIGS. 7A and 7B show graphs showing current (FIG. 7A) and optical density responses (FIG. 7B) in the case where a constant voltage is applied to each of the elements in Example 1 and Comparative Example 1. It is found that the current and change in optical density of the element of Example 1 are by far greater than those of the element of Comparative Example 1.

The elements of Example 1 and Comparative Example were driven under the condition that the elements obtained the same change in optical density. As a result, the element of Example 1 was able to be stably driven, whereas the element of Comparative Example 1 had poor reliability in coloration and decoloration responses because a higher voltage was applied thereto.

### EXAMPLE 2

In Example 2, only the construction of the electrochromic medium differs from that in Example 1, and the other conditions are the same as those in Example 1.

The same material B as that of Example 1 was used as the anodic electrochromic material, and a material D (chemical name: diethylviologen diperchlorate) represented by the following structural formula (D) was used as the cathodic electrochromic material. The materials and tetrabutylammonium (TBAP) as a supporting electrolyte were dissolved in a propylene carbonate solvent to prepare an electrochromic medium. In this case, the concentrations of the anodic electrochromic material B and the cathodic electrochromic material D were each set to 10 mM, and the concentration of TBAP was set to 0.1 M.

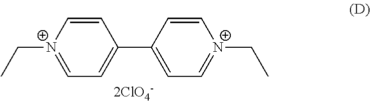 [SMILES: CC[n+]1ccc(-c2cc[n+](CC)cc2)cc1]

### COMPARATIVE EXAMPLE 2

In the second electrode of Example 2, the layer having a porous structure was not formed, and an element using an FTO thin film having a substantially flat structure as each of the first and second electrodes was produced. All the other conditions were the same as those in Example 2.

<Element Evaluation>

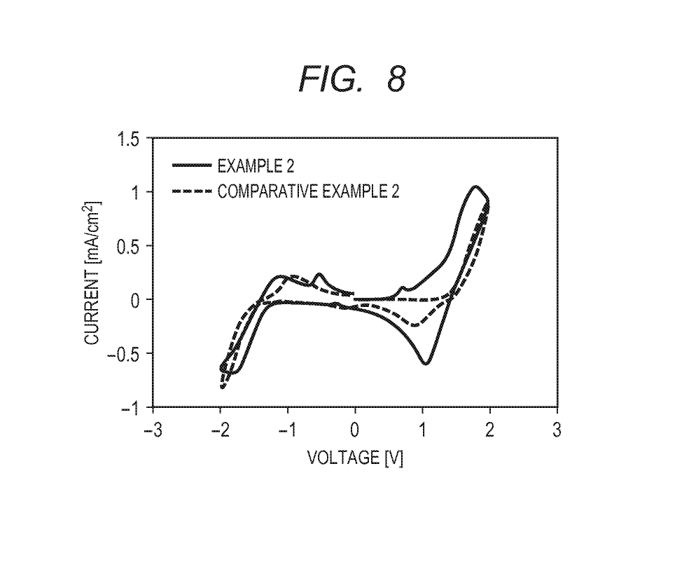

The electrochromic elements produced in Example 2 and Comparative Example 2 were each arranged in an evaluation system in which electrochemical measurement and transmittance measurement could simultaneously be performed, and were evaluated for their current-voltage characteristics and transmittance characteristics. FIG. 8 is a graph showing the cyclic voltammogram characteristics of the elements in Example 2 and Comparative Example 2.

The threshold voltage of the element of Comparative Example 2 is 1.48 V, whereas the threshold voltage of Example 2 is 0.50 V. Thus, it is found that the formation of the layer having a porous structure in the second electrode allows a current to start flowing at a lower voltage, initiating coloration. Further, it is found that: the cyclic voltammogram waveform of the element of Example 2 has an inflection point around 1.3 V; in the voltage range of from the threshold voltage, i.e., 0.50 V or more to 1.3 V or less, a reaction between the anodic electrochromic material B and the second electrode having a porous structure has occurred; and at 1.3 V or more, a reaction between the anodic electrochromic material B and each of the second electrode having a porous structure and the cathodic electrochromic material C has occurred. On the other hand, in the element of Comparative Example 2, at voltages ranging from the threshold voltage, i.e., 1.48 V or more, a reaction between the anodic electrochromic material B and the cathodic electrochromic material C has occurred. That is, it is found that the formation of the layer having a porous structure has been able to decrease the voltage at which the reaction of the cathodic electrochromic material D starts by about 0.2 V as in Example 1.

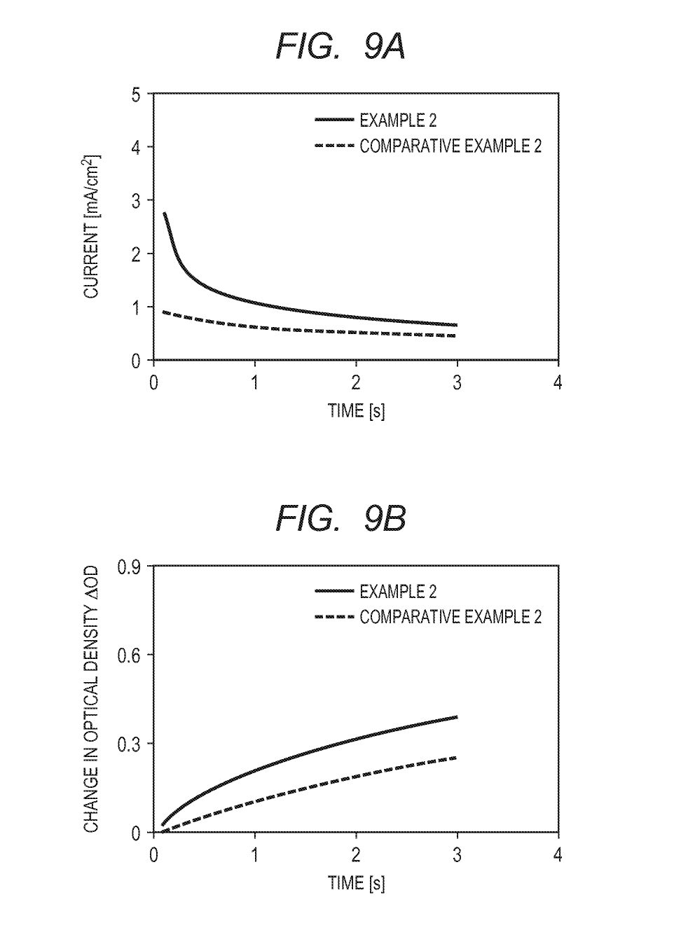

FIGS. 9A and 9B show graphs showing current (FIG. 9A) and optical density responses (FIG. 9B) in the case where a constant voltage is applied to each of the elements in Example 2 and Comparative Example 2. It is found that the current and change in optical density of the element of Example 2 are greater than those of the element of Comparative Example 2.

The elements of Example 2 and Comparative Example were driven under the condition that the elements obtained the same change in optical density. As a result, the element of Example 2 was able to be stably driven, whereas the element of Comparative Example 2 had poor reliability in coloration and decoloration responses because a higher voltage was applied thereto.

According to one embodiment of the present invention, it is possible to provide the electrochromic element that is excellent in reliability by virtue of a decreased driving voltage of the element. According to other embodiments of the present invention, it is possible to provide the image pickup optical system, the image pickup device, and the window member, each using the electrochromic element.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-011977, filed Jan. 27, 2014, which is hereby incorporated by reference herein in its entirety.

What is claimed is:

1. An electrochromic element comprising:
a pair of electrodes; and
an electrochromic medium comprising a liquid containing an electrochromic material, the electrochromic medium being arranged between the pair of electrodes,
wherein:
the electrochromic medium comprises
at least one kind of anodic electrochromic material and
at least one kind of cathodic electrochromic material;
the pair of electrodes comprises
a first electrode configured to perform oxidation-reduction of the anodic electrochromic material and
a second electrode configured to perform oxidation-reduction of the cathodic electrochromic material; and
a specific surface area of the second electrode is larger than a specific surface area of the first electrode.

2. The electrochromic element according to claim 1, wherein the specific surface area of the second electrode is 300 cm²/cm² or more.

3. The electrochromic element according to claim 1, wherein the specific surface area of the second electrode is 600 cm²/cm² or more.

4. The electrochromic element according to claim 1, wherein the second electrode has a porous structure.

5. The electrochromic element according to claim 4, wherein the porous structure of the second electrode is formed by nanoparticles.

6. The electrochromic element according to claim 4, wherein the porous structure of the second electrode is formed by tin oxide nanoparticles.

7. The electrochromic element according to claim 1, wherein the second electrode has a laminate structure including
a layer having a porous structure and
a transparent conductive layer,
the layer having a porous structure being arranged on an electrochromic medium side.

8. The electrochromic element according to claim 1, wherein the specific surface area of the first electrode is from 1 cm²/cm² or more to 30 cm²/cm² or less.

9. An image pickup optical system comprising:
the electrochromic element according to claim 1; and
a circuit configured to drive the electrochromic element.

10. An image pickup device comprising:
the electrochromic element according to claim 1;
a circuit configured to drive the electrochromic element; and
an image pickup element configured to receive light that has passed through the electrochromic element.

11. An image pickup device comprising:
a circuit configured to drive the electrochromic element according to claim 1; and
an image pickup element configured to receive external light.

12. A window member comprising:
the electrochromic element according to claim 1; and
a circuit configured to drive the electrochromic element.
